(19) United States
(12) Patent Application Publication
(10) Pub. No.: US 2011/0291876 A1
(43) Pub. Date: Dec. 1, 2011

(54) Doppler-Vision-Radar Traffic Surveillance System

(76) Inventors: Lang Hong, Beavercreek, OH (US); Steven Siying Hong, Beavercreek, OH (US)

(21) Appl. No.: 12/790,817

(22) Filed: May 29, 2010

(51) Int. Cl. G01S 13/58

(52) U.S. Cl. 342/113

(57) ABSTRACT

This invention is related to a Doppler-Vision-Radar Traffic Surveillance System comprising of multiple Doppler radars, circuitry for processing radar signals, and data recording and displaying devices. Although the system is mainly designed for roadside traffic surveillance, it can be used in different applications, such as mounted on a host vehicle or on a UAV. The system will provide continuous surveillance of all incoming and leaving traffic.

### TECHNICAL FIELD

This invention relates to a Doppler-vision-radar traffic surveillance system.

### BACKGROUND OF THE INVENTION

Doppler Radar Based Traffic Surveillance Systems: A traditional radar based traffic surveillance system uses a Doppler radar for vehicle speed monitoring which measures a vehicle speed at line-of-sight (LOS). In FIG. 1, the speed of an approaching (or a leaving) vehicle is calculated in terms of Doppler frequency f_{D} by

$${v}_{t} = \frac{{f}_{D}}{K cos ( {φ}_{t} )} \qquad ( 1 )$$

where K is a Doppler frequency conversion constant and φₜ is the angle between the vehicle velocity vector νₜ, and the LOS. Although an advantage of a Doppler radar based system is its long detection range, there are several difficulties associated with the traditional radar based system: (1) the Doppler radar beam angle is too large to precisely locate vehicles within the radar beam, i.e., no precise line-of-sight (LOS) angular information of the moving vehicle is available; (2) the angle between the vehicle velocity vector and the LOS, φₜ, is unknown and therefore, needs to be small enough for a reasonable speed estimation accuracy; (3) since all velocity vectors on the equal-Doppler cone in FIG. 1 generate the same speed, the Doppler radar cannot differentiate the vehicles with the same speed but moving in different directions defined by the same equal-Doppler cone. Therefore, precise vehicle speed and location information cannot be derived in a traditional Doppler radar based traffic surveillance system.

This invention overcomes the shortcoming of the traditional Doppler radar based system lacking the information of the LOS angle and the angle between the vehicle velocity vector and the LOS by using multiple Doppler radars with a special configuration to obtain the precise information of the LOS angle and the angle between the vehicle velocity vector and the LOS. The reason this patent is called “Doppler-Vision-Radar Traffic Surveillance System” is because it uses two moving radars with a specially designed motion pattern to obtain the moving vehicles' LOS angle information which normally can only be obtained by a vision system. The precise angle between the vehicle velocity vector and the LOS is used to calculate the vehicle speed and the precise LOS angle is used in the Doppler-Vision-Radar Traffic Surveillance System to pinpoint the moving vehicles.

### SUMMARY

A Doppler-vision-radar traffic surveillance system to monitor traffic may include a first movable Doppler radar to generate a first radar beam along the direction of a first motion ray, a second movable Doppler radar to generate a second radar beam along the direction of a second motion ray, a third fixed Doppler radar to generate a third radar beam along a direction ray, a data processing device to process Doppler radar information, a tracking device to continuously point the surveillance system to the moving vehicle, and a recording device to continuously record the complete information of the moving vehicle.

The surveillance system may find the line-of-sight (LOS) angle of a moving vehicle by finding a velocity vector perpendicular to the LOS vector.

The surveillance system may find the velocity vector perpendicular to the LOS vector by scaling the motion vector of one moving radar and subtracting the motion vector of the other moving radar from the scaled motion vector.

The surveillance system may scale the motion vector of one moving radar by multiplying it with a ratio of Doppler differences.

The surveillance system may find the Doppler differences by subtracting the Doppler of the fixed radar from the Doppler of two moving radars.

The surveillance system may find the vehicle heading angle information, which us the same as road structure information, using a training procedure.

The surveillance system may use radar data from multiple vehicles in the training procedure.

The surveillance system may find the vehicle speed information by jointly using three radars.

The surveillance system may track the moving vehicle by continuously pointing to the vehicle using the vehicle LOS angle information.

The surveillance system may record the moving vehicle speed and LOS angle information onto a recording device.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates the speed measurement of an approaching vehicle and a leaving vehicle with a Doppler radar;

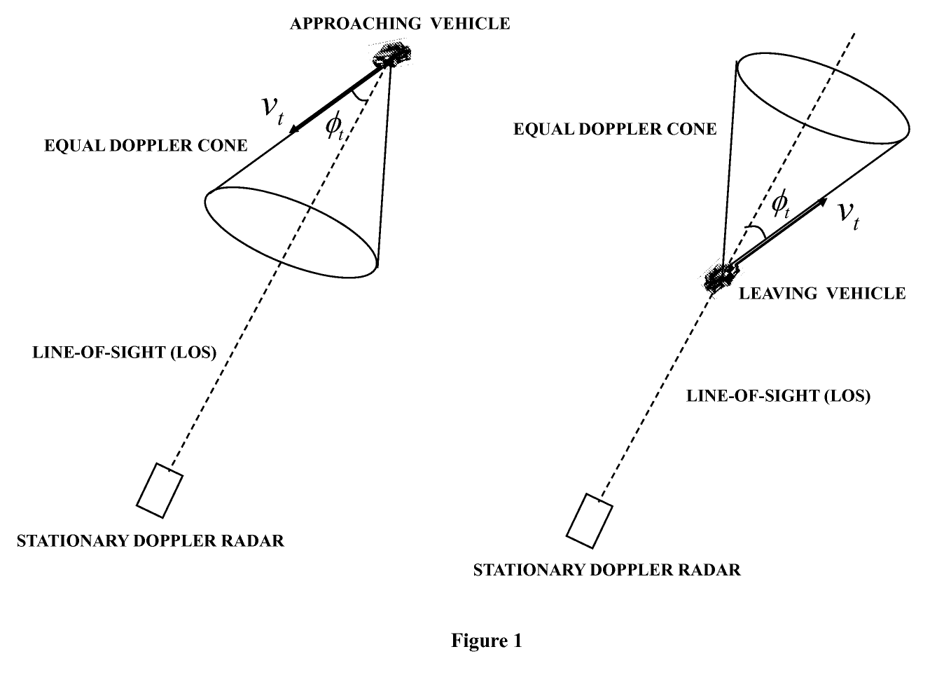

FIG. 2 illustrates the operational setup of the surveillance system;

FIG. 3 illustrates the lay out of the surveillance system;

FIG. 4 illustrates the functional flow chart of the surveillance system; and

FIG. 5 illustrates three radar configuration and the two moving radar motion pattern.

### DETAILED DESCRIPTION

While the term “traffic surveillance” is used herein, it may also refer to other traffic applications, such as “traffic monitoring”, etc. The invention discussed here may be applied to the case of more than three radars.

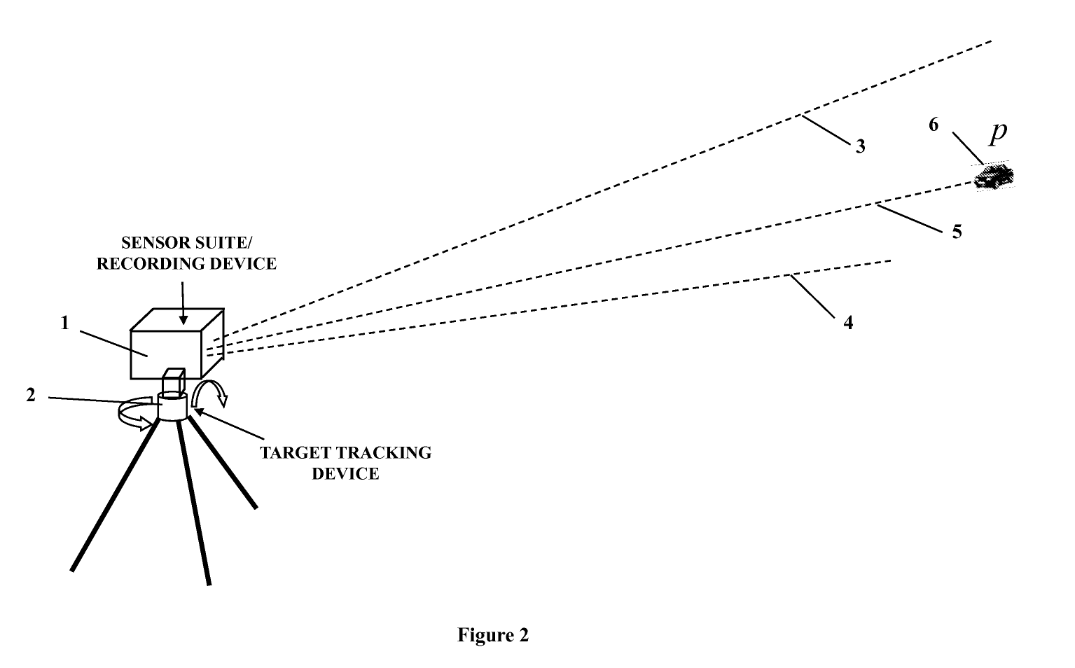

A Doppler-vision-radar traffic surveillance system is shown in FIG. 2 where 1—the sensor system which may include a sensor suite/recording device or apparatus, 2—a target tracking device, 3—a first moving Doppler radar motion ray, 4—a second moving Doppler radar motion ray, and 5—a radar direction ray connecting the sensor apparatus 1 to a moving vehicle 6.

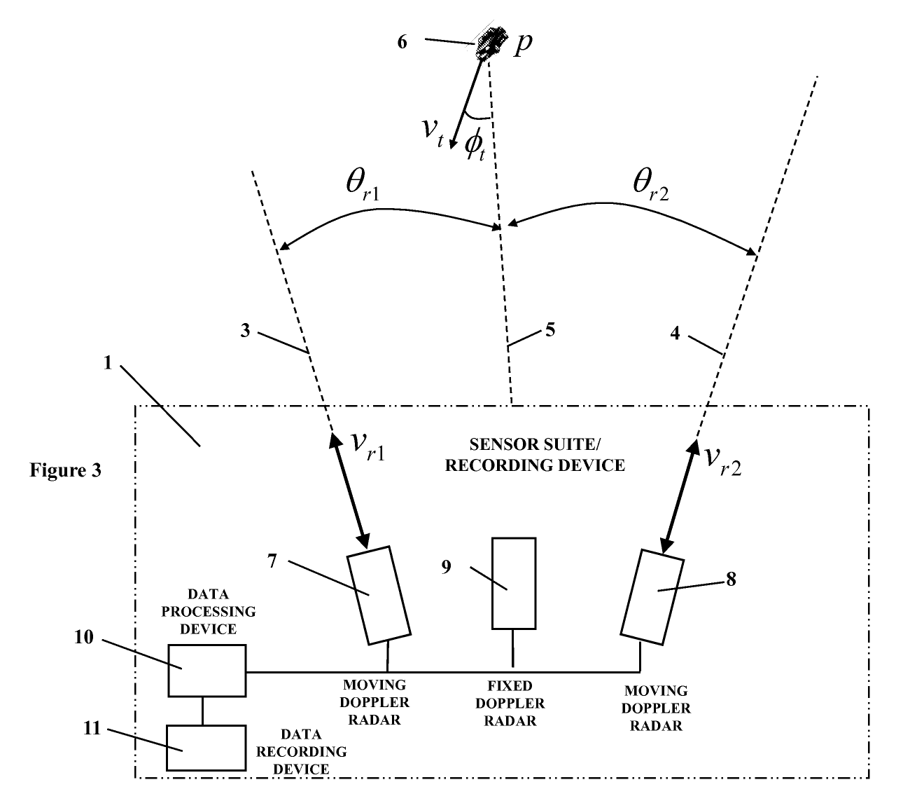

FIG. 3 shows the layout of the sensor apparatus 1 where 7—a first moving Doppler radar, 8—a second moving Doppler radar, 9—a fixed or stationary Doppler radar, 10—a data processing device, such as a computer, laptop, personal computer, PDA or other such device, and 11—data recording device, such as a hard drive, a flash drive or other such device.

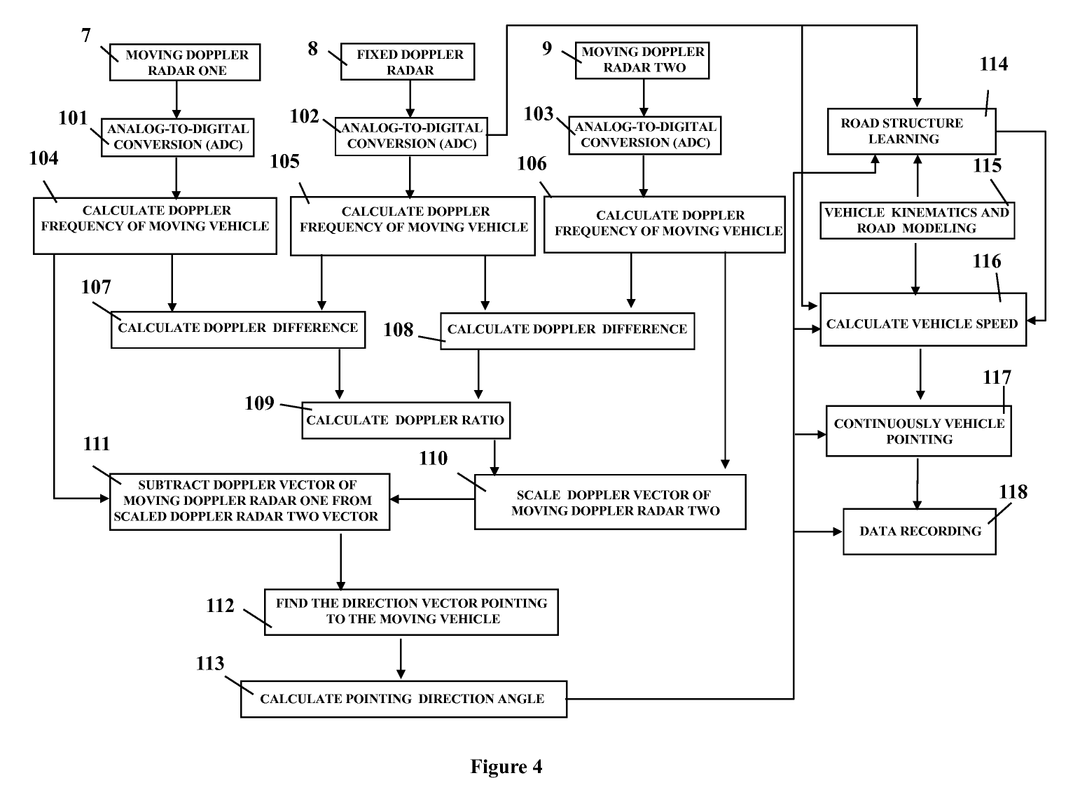

The functional flow chart of the system is shown in FIG. 4. In the following, we will describe the functional blocks.

### 1. Analog-to-Digital Conversion (ADC) for Doppler Radars

Doppler radars illustrated in this patent are continuous wave (CW) radars. Analog-to-digital conversion (ADC) may be performed in 101, 102 and 103 to convert analog signals to digital signals. If digital signals are directly available from the radars, this ADC step may be skipped.

### 2. Calculate Doppler Frequency of the Moving Vehicle

Assume the current time is k in discrete time. The Doppler frequencies of the moving vehicle p, 6 in FIG. 3, induced by both moving Doppler radars may be given by (steps 104 and 106 in FIG. 4)

f_{D}_{ₖ}¹=K₁[νₜₖ cos(φₜₖ)+νᵣ₁ₖ cos(θᵣ₁ₖ)] (1)

and

f_{D}_{ₖ}²=K₂[νₜₖ cos(φₜₖ)+νᵣ₂ₖ cos(θᵣ₂ₖ)]. (2)

where K₁ and K₂ may be Doppler conversion constants for the first and second moving Doppler radars (7 and 8 in FIG. 3), and θᵣ₁ₖ, θᵣ₂ₖ and θₜₖ are depicted in FIG. 3 without time index k. A fixed Doppler radar 9 may be used to sense the moving vehicle motion (step 105 in FIG. 4)

f_{D}_{ₖ}³=K₃νₜₖ cos(φₜₖ) (3)

where K₃ may be the Doppler conversion constant for the fixed Doppler radar (9 in FIG. 3).

### 3. Calculate Doppler Differences

In steps 107 and 108 of FIG. 4, since all three radars 7, 8, 9 may be located together and assuming that the distance from the sensor suite to the moving vehicle 6 may be much larger than the distance between radars 7, 8, 9, the following Doppler differences may be obtained as

$$\begin{matrix}Δ {f}_{{D}_{k}}^{13} = \frac{{f}_{{D}_{k}}^{1}}{{K}_{1}} - \frac{{f}_{{D}_{k}}^{3}}{{K}_{3}} = {v}_{r 1 k} cos ( {θ}_{r 1 k} ) \\ and & ( 4 ) \\ Δ {f}_{{D}_{k}}^{23} = \frac{{f}_{{D}_{k}}^{2}}{{K}_{2}} - \frac{{f}_{{D}_{k}}^{3}}{{K}_{3}} = {v}_{r 2 k} cos ( {θ}_{r 2 k} ) & ( 5 )\end{matrix}$$

where the impact of the moving vehicle may have been removed. Eqs. (4) and (5) may actually recover the substantially independent motion Doppler signals of the first and second moving Doppler radars 7, 8, except for the conversion constants.

### 4. Calculate Doppler Ratio

In step 109, the Doppler ratio may be calculated as

$$\frac{Δ {f}_{{D}_{k}}^{13}}{Δ {f}_{{D}_{k}}^{23}} = \frac{{v}_{r 1 k} cos ( {θ}_{r 1 k} )}{{v}_{r 2 k} cos ( {θ}_{r 2 k} )} . \qquad ( 6 )$$

### 5. Scale Doppler Vector of Moving Doppler Radar Two

In step 110, the Doppler vector of moving radar two may be scaled as

$${\underline{\overline{v}}}_{r 2 k} = \frac{Δ {f}_{{D}_{k}}^{13}}{Δ {f}_{{D}_{k}}^{23}} {\underline{v}}_{r 2 k} . \qquad ( 7 )$$

6. Subtract the Doppler Vector of Moving Radar One from the Scaled Doppler Vector

In step 111, the Doppler vector of moving radar one may be subtracted from the scaled Doppler vector of moving radar two

νᵣ₁₂ₖ= θ̅ᵣ₁₂ₖ−νᵣ₁ₖ. (8)

### 7. Find the Directional Vector Pointing to Moving Vehicle

In step 112 of FIG. 4, the direction vector nₖ pointing to the moving vehicle perpendicular to νᵣ₁₂ₖ may be found, and a pointing direction angle αₖ (step 113 in FIG. 4) may be calculated. This pointing direction angle is the LOS angle of the moving vehicle.

### 8. Road Structure Learning

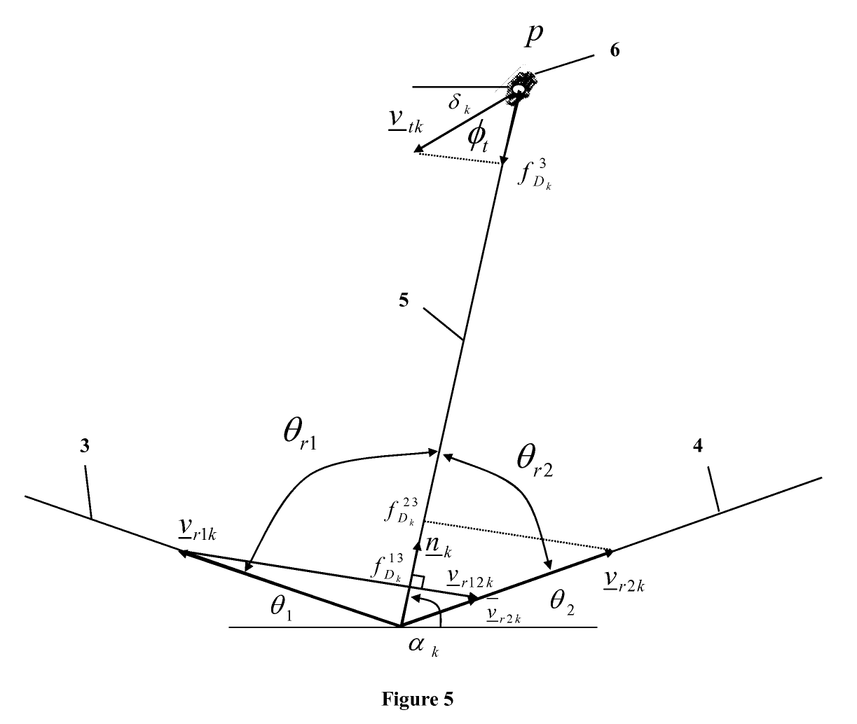

From FIG. 5, the following may be obtained:

φₜₖ=αₖ−δₖ. (9)

Eq. (3) may be rewritten as

$$\begin{matrix}{f}_{{D}_{k}}^{3} = {K}_{3} {v}_{tk} cos ( {α}_{k} - {δ}_{k} ) \\ = {λ}_{1} cos ( {α}_{k} ) + {λ}_{2} sin ( {α}_{k} )\end{matrix} \qquad ( 10 )$$

where λ₁ and λ₂ may be

λ₁=K₃νₜₖ cos(δₖ),λ₂=K₃νₜₖ sin(δₖ). (11)

By modeling the vehicle's kinematics with a constant velocity model and the road structure with a straight line model (step 115 in FIG. 4), Eq. (11) may become

λ₁=K₃νₜ cos(δ),λ₂=K₃νₜ sin(δ). (12)

We may assume that the vehicles may follow the road lane markings and the vehicle's heading angle (λₖ in FIG. 5) may reflect the road structure which may be learnt from the traffic flow (step 114 in FIG. 4).

With a collection of N Doppler frequencies of the fixed Doppler radar, a least square approach may be used to calculate \hat{λ}₁ and \hat{λ}₂ using Eq. (10). The road structure may be calculated by (steps 114 of FIG. 4)

$$\hat{δ} = {tan}^{- 1} ( \frac{{λ}_{2}}{{λ}_{1}} ) . \qquad ( 13 )$$

Note: A different moving vehicle heading direction may result in different signs of angles in Eq. (9).

### 9. Calculate Vehicle Speed

Once the road structure \hat{δ} is learnt, accurate vehicle speed \hat{ν}ₜₖ may be calculated from (step 116 in FIG. 4)

f_{D}_{ₖ}³=K₃νₜₖ cos(\hat{α}ₖ−\hat{δ}ₖ). (14)

### 10. Continuously Vehicle Pointing

Once the pointing direction angle, \hat{α}ₖ, is known, the target tracking device (2 in FIG. 2 and step 117 in FIG. 4) may continuously point to the vehicle to maintain continuous surveillance.

### 11. Data Recording

Each vehicle's speed \hat{ν}ₜₖ and direction angle \hat{α}ₖ are continuously recorded in the data recording device (11 in FIG. 3 and step 118 in FIG. 4).

FIG. 5 shows the motion pattern of two moving Doppler radars whose motion vectors, νᵣ₁ₖ and νᵣ₂ₖ, are defined by angles, θ₁ and θ₂, along the radar motion rays, 3 and 4. FIG. 5 also shows the relationship between the scaled motion vector, ν̅ᵣ₂ₖ and its perpendicular vector, νᵣ₁₂ₖ, and the relationship between the perpendicular vector and the moving vehicle direction vector, nₖ, and the vehicle LOS angle, αₖ.

Note: This patent application is in reference to the following patent applications of both inventors: Application Numbers 12255081 and 12266227. Patent Applications 12255081 is for 3D imaging where it uses three radars and one video camera and requires the sensor suite to move with a known motion. Patent Applications 12266227 requires also three radars and a video camera and precise registration between the radars and the camera is needed. This patent application is also in reference to the following patent application of the first inventor: Application Number 12333735, where it also requires three radars and one video camera and a fusion algorithm of radar and video signals is presented. This invention uses only three radars and no cameras, but recovers the same information as a camera.

1. A system for determining an angle of a moving vehicle, comprising:
a first movable Doppler radar to generate a first radar motion vector;
a second movable Doppler radar to generate a second radar motion vector;
a fixed Doppler radar to generate a radar direction vector,
wherein said first and second movable Doppler radars move with respect to said fixed Doppler radar.

2. The system for determining an angle of a moving vehicle, comprising:
a first movable Doppler radar to generate a first radar motion vector;
a second movable Doppler radar to generate a second radar motion vector;
a fixed Doppler radar to generate a radar direction vector,
wherein said system generates a first Doppler difference based upon the difference between said first movable Doppler radar and said fixed Doppler radar, and generates a second Doppler difference based upon the difference between said second movable Doppler radar and said fixed Doppler radar.

3. (canceled)

4. The system for determining an angle of a moving vehicle as recited in claim 2, a wherein said system generates a Doppler ratio of said first Doppler difference and said second Doppler difference.

5. The system for determining an angle of a moving vehicle as recited in claim 4, wherein said system generates a scaled motion vector of one movable Doppler radar based on said Doppler ratio.

6. The system for determining an angle of a moving vehicle as recited in claim 5, wherein said system generates a vector perpendicular to said radar direction vector based on said scaled motion vector and the motion vector of the other movable Doppler radar.

7. The system for determining an angle of a moving vehicle as recited in claim 6, wherein said system generates the angle of said moving vehicle based on said perpendicular vector.

8. The system for determining an angle of a moving vehicle as recited in claim 7, wherein said angle is defined in a radar reference coordinate.

9. (canceled)

10. (canceled)

11. (canceled)

12. (canceled)

13. (canceled)

14. (canceled)
